(19) United States
(12) Patent Application Publication
(10) Pub. No.: US 2016/0327672 A1
(43) Pub. Date: Nov. 10, 2016

(54) SYSTEMS AND METHODS FOR DESTRIPING SEISMIC DATA

(71) Applicant: CGG SERVICES SA, Massy (FR)

(72) Inventors: Céline LACOMBE, Massy (FR); Henning HOEBER, East Grinstead (GB); Arash JAFARGANDOMI, Crawley (GB)

(21) Appl. No.: 15/109,174

(22) PCT Filed: Jan. 8, 2015
(86) PCT No.: PCT/IB2015/000176

§ 371 Date: Jun. 30, 2016

Related U.S. Application Data
(60) Provisional application No. 62/002,193, filed on May 23, 2014.
(60) Provisional application No. 61/925,683, filed on Jan. 10, 2014.

(51) Int. Cl. G01V 1/36; G01V 1/38

(52) U.S. Cl. CPC G01V 1/366; G01V 1/38; G01V 2210/612

(57) ABSTRACT

Systems and method for improved analysis of seismic data are provided. The method includes obtaining seismic data including a plurality of vintages, and generating a plurality of attribute matrices based on the seismic data. The method further includes computing a centrality measure for each vintage of the plurality of vintages using the plurality of attribute matrices, and selecting, from the plurality of vintages, a vintage with the highest centrality measure as a reference vintage. Additionally, the method includes determining an oulier from the plurality of vintages based on correlating each of the plurality of vintages with the reference vintage.

### CROSS-REFERENCE TO RELATED APPLICATION

This application claims the benefit under 35 U.S.C. § 119(e) of U.S. Provisional Application Ser. No. 62/002,193 filed on May 23, 2014 and United States Provisional Application Ser. No. 61/925,683 filed on Jan.y 10, 2014, which are incorporated by reference in their entirety for all purposes.

### TECHNICAL FIELD

The present invention relates generally to seismic exploration and, more particularly, to systems and methods for destriping seismic data.

### BACKGROUND

In recent years, offshore drilling has become an increasingly important method of locating and retrieving oil and gas. However, because drilling offshore involves high costs and high risks, marine seismic surveys are used to produce an image of subsurface geological structures. Marine seismic surveys are usually accomplished by marine survey ships towing a signal source and/or seismic sensors.

Each seismic sensor, or “sensor,” may be a hydrophone, which detects variations in pressure below the ocean surface. The sensors are contained within or attached to a cable that is towed behind the moving ship. The cables are often multiple kilometers in length and each has many sensors. The towing process is referred to as “streaming” the cable, and the cables themselves are referred to as “streamer cables” or “streamers.” For example, typically streamers can be approximately three to twelve kilometers in length. The distance between streamers perpendicular to the direction of movement of the vessel may be referred to as the “crossline streamer separation.” The total crossline distance from the first streamer to the last streamer may be referred to as “spread width.” For example, a vessel may tow approximately eight streamers at approximately seventy-five meter crossline streamer separation for a total spread width of approximately 500 hundred to 600 hundred meters. Spread widths can be designed up to approximately 1,200 meters.

Vessels can also tow one or more sources. The source generates a seismic signal, which is a series of seismic waves that travel in various directions including toward the ocean floor. The seismic waves penetrate the ocean floor and are at least partially reflected by interfaces between subsurface layers having different seismic wave propagation speeds. Sensors detect and receive these reflected waves. Sensors transform the seismic waves into seismic traces suitable for analysis. Sensors are in communication with a computer or recording system, which records the seismic traces from each sensor.

Once an acquisition area is defined, one or more vessels may start at one end of the area, travel across the area while recording seismic traces. The trajectory of movement across the acquisition area may be referred to as a “sail-line” or “acquisition line.” Each sail-line may be assigned a sail-line number or “sequence number.” When clear of the acquisition area, the vessels may turn around and travel back over the acquisition area, creating another sail-line or acquisition number.

Seismic data typically includes traces associated with locations. Because sensors are on streamers, the locations are aligned along lines yielding 2D images. When multiple parallel streamers acquire data, interpolating the 2D images corresponding to each streamer yields 3D data, and the corresponding survey is called a “3D seismic survey” or “3D survey.”

The term “4D survey” is used when 3D seismic surveys are repeated over the same location over a period of time. In 4D surveys, also called “time-lapse monitoring,” sources and sensors repeat a seismic survey over a defined time interval. Each survey—or “vintage”—can be performed hours, days, weeks, or months apart. 4D surveys may be utilized once hydrocarbon reservoirs have been put into production, and may be useful to obtain ongoing seismic measurements to monitor characteristics of the underground hydrocarbon reservoir over time. 4D surveys, or multiple acquisitions over time, may be used to identify and monitor changes in reservoirs. However, during the acquisition of 4D data, environmental conditions change between surveys. For example, during the acquisition of a marine survey, tidal effects, water temperature, and other factors may vary between vintages. Such factors may create amplitude, time-shift and possibly phase differences between the different acquisition lines (sail-lines) and the different surveys. These differences vary with the time of acquisition—and therefore with the sail-line—and may manifest as sail-line correlated stripes on attribute maps. An attribute is a quantity extracted or derived from seismic data that can be analyzed to yield additional data regarding the subsurface geology. Attributes may include time, amplitude, phase, and other suitable parameters. Stripes may interfere with the processing of seismic data. Thus, it would be useful to provide systems and methods to remove such stripes from the received seismic data.

### SUMMARY

In accordance with some embodiments of the present disclosure, a method for improved analysis of seismic data is provided. The method includes obtaining seismic data including a plurality of vintages, and generating a plurality of attribute matrices based on the seismic data. The method further includes computing a centrality measure for each vintage of the plurality of vintages using the plurality of attribute matrices, and selecting, from the plurality of vintages, a vintage with the highest centrality measure as a reference vintage. Additionally, the method includes determining an outlier from the plurality of vintages based on correlating each of the plurality of vintages with the reference vintage.

In accordance with another embodiment of the present disclosure, a seismic processing system includes a computing system. The computing system is configured to obtain seismic data including a plurality of vintages, generate a plurality of attribute matrices based on the seismic data, and compute a centrality measure for each vintage of the plurality of vintages using the plurality of attribute matrices. The computing system is further configured to select, from the plurality of vintages, a vintage with the highest centrality measure as a reference vintage, and determine an outlier from the plurality of vintages based on correlating each of the plurality of vintages with the reference vintage.

In accordance with another embodiment of the present disclosure, a non-transitory computer-readable medium includes instructions that, when executed by a processor, cause the processor to obtain seismic data including a plurality of vintages, generate a plurality of attribute matrices based on the seismic data, and compute a centrality measure for each vintage of the plurality of vintages using the plurality of attribute matrices. The processor is further caused to select, from the plurality of vintages, a vintage with the highest centrality measure as a reference vintage, and determine an outlier from the plurality of vintages based on correlating each of the plurality of vintages with the reference vintage.

### BRIEF DESCRIPTION OF THE DRAWINGS

For a more complete understanding of the present disclosure and its features and advantages, reference is now made to the following description, taken in conjunction with the accompanying drawings, in which like reference numbers indicate like features and wherein:

FIG. 1 illustrates exemplary attribute maps of multi-vintage 4D seismic data in accordance with some embodiments of the present disclosure;

FIG. 2 illustrates exemplary bias-corrected attribute maps after removal of DC bias from the attribute maps of FIG. 1 in accordance with some embodiments of the present disclosure;

FIG. 3 illustrates exemplary z-score attribute maps with outliers identified in accordance with some embodiments of the present disclosure;

FIG. 4 illustrates exemplary stripe maps linked to vintages in accordance with some embodiments of the present disclosure;

FIG. 5 illustrates a flow chart of an example method of destriping seismic data using a z-score method in accordance with some embodiments of the present disclosure;

FIG. 6A illustrates a flow chart of an example method of destriping seismic data using a centrality measure in accordance with some embodiments of the present disclosure;

FIG. 6B illustrates plots of exemplary traces to which a centrality measure is applied in accordance with some embodiments of the present disclosure;

FIG. 7A illustrates a top view of an example marine seismic survey system in accordance with some embodiments of the present disclosure;

FIG. 7B illustrates an exemplary side view of the example marine seismic survey system of FIG. 7A in accordance with some embodiments of the present disclosure; and

FIG. 8 illustrates a schematic diagram of an example system that can be used to destripe seismic data in accordance with some embodiments of the present disclosure.

### DETAILED DESCRIPTION

Differences appear on different vintages of 4D surveys based on environmental factors, such as tidal effects, water temperature, and other factors that vary between vintages. These differences create amplitude, time-shift, and phase differences between the different sail-lines and the different vintages. The difference may be evident as sail-line correlated stripes on attribute maps. Attribute maps include amplitude or horizon time maps for 3D data, and time-shift or root-mean-squared (RMS) ratio maps for 4D data. While processing may correct for some environmental effects, some residual amplitude, time-shift and phase differences may still exist and may need to be corrected. Correcting seismic data to remove such differences may be referred to as “acquisition footprint removal” or “destriping.”

Accordingly, in some embodiments, systems and methods are presented to destripe data generated in seismic surveys. The destriping may be guided by an acquisition attribute related to the seismic survey. In marine surveys, stripes based on environmental effects that appear in the seismic data may be consistent along a sail-line. Thus, in some embodiments, the sequence number, for example the sail-line number, may be used as the acquisition attribute. In some embodiments, a methodology is disclosed to destripe seismic data by using a z-score method guided by an acquisition attribute, such as the sail-line number. By enhancing the z-score method with a guiding acquisition attribute, improvements in seismic data analysis may be realized. Additionally, the resulting attribute maps may be filtered along the acquisition attributes.

Further, in some embodiments, destriping may be accomplished by matching seismic data to a reference trace or vintage and determining the difference between the seismic data and the reference. Selecting the reference trace or vintage is accomplished by a variety of methods that often result in different traces being selected as the reference. Because the accuracy of destriping is based on the selected reference trace or vintage, methods for improvements in identification of the reference trace or vintage may be useful. In some embodiments, a system and method for selection of a reference traces or vintages based on network theory, and more specifically, centrality, is disclosed.

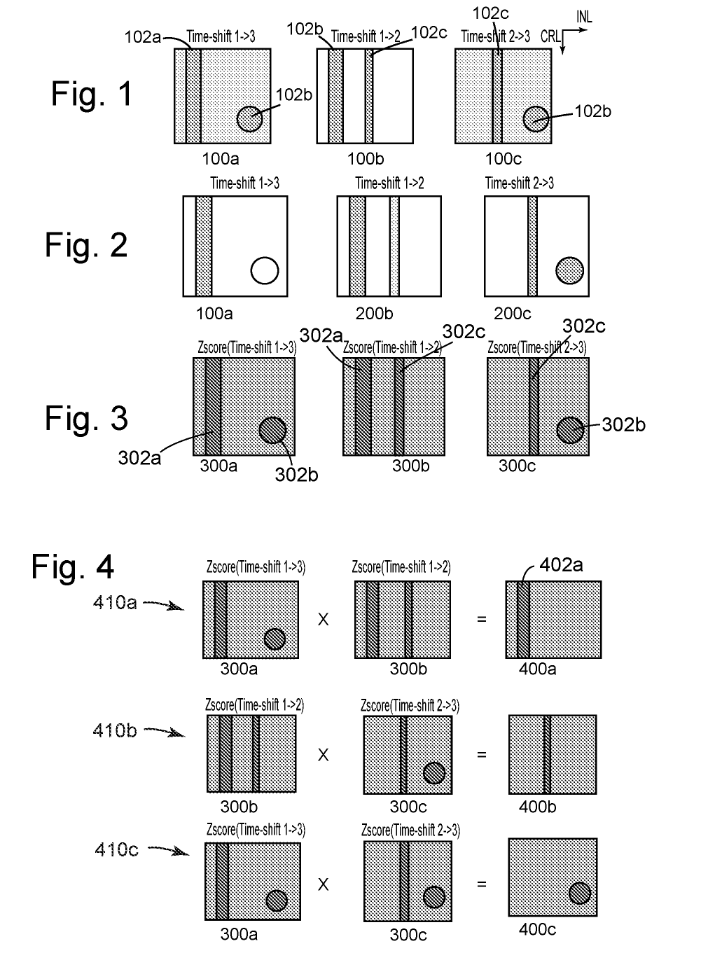

FIG. 1 illustrates exemplary attribute maps 100 of multi-vintage 4D seismic data in accordance with some embodiments of the present disclosure. Attribute maps 100a, 100b, and 100c (collectively “attribute maps 100”) may be produced based on a dataset generated from multiple vintages created by performing a seismic survey and recording seismic data for multiple iterations over time. For example, attribute maps 100 may be based on combinations of a seismic dataset made of three vintages. Attribute maps 100 may further represent any suitable 4D attribute. For example, attribute maps 100 may be time-shift maps in which each attribute map is based on a combination of vintages and may be a function of crossline and inline sensors. Attribute map 100a may be a time-shift map of vintages one and three. Attribute map 100b may be a time-shift map of vintages one and two, and attribute map 100c may be a time-shift map of vintages two and three. Further, noise 102 from a variety of sources may appear on attribute maps 100. For example, noise 102a and 102b may be visible on attribute map 100a. Noise 102a and 102c may be visible on attribute map 100b, and noise 102b and 102c may be visible on attribute map 100c. Because attribute maps 100 are a function of the sensor geometry, for example, a function of crossline and inline sensors, some noise may be evident based on the sail-line number.

FIG. 2 illustrates exemplary bias-corrected attribute maps 200 after removal of DC bias from attribute maps 100 of FIG. 1 in accordance with some embodiments of the present disclosure. In the time domain, DC bias is the mean or median of a waveform. Removing DC bias, such that the amplitude of each map has a zero mean, may be useful in analyzing time-shift attribute maps. Any suitable method for removing DC bias may be performed on attribute maps 100a, 100b, and 100c. For example, the median value associated with each attribute map 100 may be calculated and subtracted from each attribute map. Accordingly, bias-corrected attribute map 200a is a time-shift map of vintages one and three with DC bias removed, bias-corrected attribute map 200b is a time-shift map of vintages one and two with DC bias removed, and bias-corrected attribute map 200c is a time-shift map of vintages two and three with DC bias removed.

FIG. 3 illustrates exemplary z-score attribute maps 300 with outliers 302 identified in accordance with some embodiments of the present disclosure. Outliers 302 may be generated by machinery, environmental changes, streamers or other sources. Identification of outliers 302 may be accomplished by any suitable method. For example, outliers may be identified by a z-score method. The z-score indicates the number of standard deviations from the mean for a particular value. Calculating the z-score may identify stripes and other noise that may be outliers on the time-shift attribute maps.

After the removal of DC bias, each of the bias-corrected attribute maps 200, discussed with reference to FIG. 2, have a zero mean. To apply the z-score method, each of the bias-corrected attribute maps 200 is divided by its standard deviation and 1 is subtracted from the absolute value of the data. All remaining positive values are outliers and are set to one. All negative values are not outliers and are set to zero. Thus, attribute maps 100a, 100b and 100c are transformed into z-score attribute maps 300a, 300b, and 300c that may contain only two values, one and zero. For example, z-score attribute map 300a includes outliers 302a and 302b with a value of one. As additional examples, z-score attribute map 300b includes outliers 302a and 302c, and z-score attribute map 300c includes outliers 302c and 302b.

FIG. 4 illustrates exemplary stripe maps 400 linked to vintages in accordance with some embodiments of the present disclosure. Using the z-score attribute maps 300, each outlier 302 may be linked to a particular vintage. An outlier related to a particular vintage may show up on the z-score attribute maps that are based on that particular vintage. For example, an outlier related to vintage one may be visible on z-score attribute map 300a based on a time shift from vintage one to three, and z-score attribute map 300b based on a time-shift from vintage one to two. Because the z-score attribute maps include only ones and zeros, multiplication of z-score attribute map 300a and z-score attribute map 300b results in stripe map 400 containing outlier 402a that is associated with vintage one. For example, calculation 410a illustrates z-score attribute map 300a multiplied by z-score attribute map 300b to produce stripe map 400a containing outlier 402a for vintage one. Calculation 410b illustrates z-score attribute map 300b multiplied by z-score attribute map 300c to produce stripe map 400b containing outlier 402b for vintage two. Calculation 410c illustrates z-score attribute map 300a multiplied by z-score attribute map 300c to produce stripe map 400c containing outlier 402c for vintage three.

In some embodiments, stripe map 400 for each vintage may be correlated with a sequence number map. The sequence number map may be multiplied by the stripe map. Since the stripe map includes only one and zero, only the sequences where the stripes are visible will be present following multiplication. However, if one stripe is linked to multiple sequence numbers, the multiplication of the stripe map and the sequence map may not be as useful. In such a case, a distribution of the represented sequences on the map may be generated and the sequences most represented may be corrected. Additional destriping may be completed if further sequence numbers are accounted for.

In some embodiments, for each vintage and sequences that are anomalous, the time-shift to be applied may be calculated using the following equation:

dTᵢ=1/(N−1)Σ_{i≠j}Δt_{i,j} (1)

where, in this case:
N=number of z-score attribute maps; and
Δt_{i,j}=the time-shift between z-score attribute maps i and j.
   For example, the time-shift to be applied to vintage one may be: dT₁=W₁Δt_{1→3}+(1−W₁)Δt_{1→2}, where W₁ indicates a weight (e.g., 0.5). The time-shift may then be smoothed along the sail-line.

In some embodiments, 3D data may be utilized in place of 4D data. The z-score may be utilized to calculate that stripe location, however, because there is only one vintage, the calculation discussed with reference to FIG. 4 may not be useful. Further, when stripes are not stationary, the method discussed with reference to FIGS. 1 through 4 may be utilized on vintages based on different time-windows.

In some embodiments, the 4D data may have only two vintages. In such a case, the vintage less contaminated by stripes may be selected as a “reference” vintage. The reference vintage may be destriped as if it were 3D data. The time-shift between the destriped reference and the other vintage may be calculated, and the time-shift map may be correlated with the sequence number map and then the time-shifts may be applied. In some embodiments, the destriping method of the present disclosure may allow for attribute guided destriping. Further, the present disclosure may not necessitate the designation or generation of a reference vintage, and may reduce or eliminate stripes being smeared or visible on other vintages.

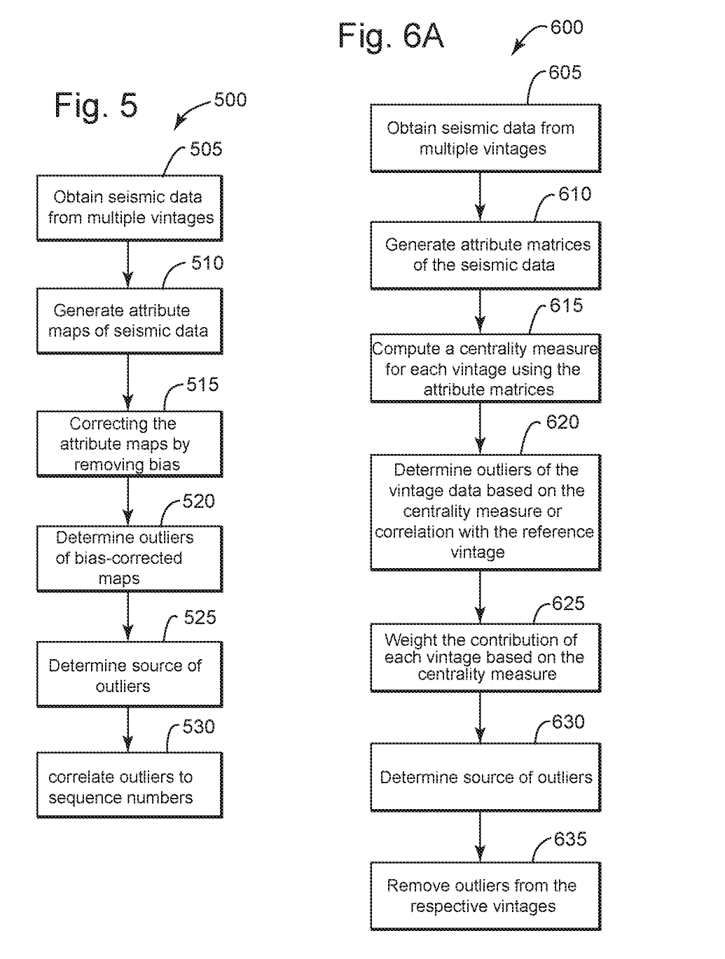

FIG. 5 illustrates a flow chart of an example method 500 of destriping seismic data using a z-score method in accordance with some embodiments of the present disclosure. The steps of method 500 are performed by a user, various computer programs, models configured to process or analyze seismic data, or any combination thereof. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze seismic data may be referred to as a “computing system.” For illustrative purposes, method 500 is described with respect to attribute maps 100 of seismic data shown in FIG. 1; however, method 500 may be used to destripe seismic data for any suitable seismic dataset.

At step 505, the computing system obtains seismic data from multiple vintages. For example, the computing system may receive seismic data from 4D seismic surveys for three different vintages. As discussed with reference to FIG. 1, the data may be based on collecting data from the same acquisition area at three different times.

At step 510, the computing system generates attribute maps of the seismic data. Any of a variety of attributes of the seismic data may be chosen. For example, the computing system may generate time-shifts maps by correlation of the different vintages, such as attribute maps 100.

At step 515, the computing system corrects the attribute maps by removing bias from the attribute maps. For example, the computing system may remove DC-bias from the attribute maps by calculating the median of the maps and subtracting that amount. After removing bias, the bias-corrected attribute maps, such as bias-corrected attribute maps 200, may be adjusted to have a zero mean.

At step 520, the computing system determines outliers of the bias-corrected attribute maps. Outliers may be an indication of noise that should be removed from the data. For example, the outliers may be identified using a z-score method. With the z-score method, the bias-corrected attribute maps are divided by their standard deviation and 1 is subtracted from the absolute value. The remaining positive values are set to one and the negative values are set to zero, as shown in z-score attribute maps 300 discussed with reference to FIG. 3.

At step 525, the computing system determines the source of any outliers. To determine the source, or vintage, of a particular outlier, the z-score attribute maps related to a particular vintage should be multiplied. For example, to determine if an outlier is from vintage one, the z-score attribute map based on the time shift between vintages one and two and the z-score attribute map based on the time shift between vintages one and three are multiplied. Because outliers are set to one and other data is set to zero, the remaining stripes after multiplication are from vintage one.

At step 530, the computing system correlates the outliers to sequence numbers or sail-lines. For example, a sequence number map may be multiplied by the stripe map for a particular vintage. Because the stripe map contains only one and zero, only the sequence numbers correlating to the stripes may remain after multiplication. As such, the sequence numbers that contribute to the stripes may be identified and corrected. The corrected seismic data may be subsequently utilized to generate images of the subsurface.

Modifications, additions, or omissions may be made to method 500 without departing from the scope of the present disclosure. For example, the order of the steps may be performed in a different manner than that described and some steps may be performed at the same time. Additionally, each individual step may include additional steps without departing from the scope of the present disclosure.

In some embodiments, seismic data may be destriped by matching seismic data to a reference trace or vintage and determining the difference between the data and the reference. Selecting the reference trace or vintage may be based on network theory and centrality. Many algorithms in seismic processing utilize reference traces or vintages, such as optimal and weighted stacking, balancing a group of traces in a gather, gather flattening and other time-alignment problems in 3D, and destriping, such as time, amplitude, and phase-corrections, in 4D surveys, in particular in multi-vintage 4D surveys. These algorithms are concerned with enhancing common features and proceed by choosing the reference and matching data to the reference.

In some embodiments, choosing the reference trace or vintage may be improved by using centrality to identify a reference trace or vintage. Centrality is a measure used to identify the relative importance of a trace or vintage to the data, or to identify the most prominent and influential trace or vintage. Within a group of traces or vintages, the trace or vintage with the highest centrality is identified as the reference. The value of centrality may also be used as weight for each trace or vintage within the group of traces or vintages. Using centrality provides advantages over other methods for identifying a reference trace or vintage. For example, in a cascaded method, one of the vintages is chosen as a fixed reference and the other data is mapped to it. However, such a method may propagate any acquisition artifacts or errors in the reference vintage to the other vintages. As another example, in the simultaneous multi-vintage method, the data is corrected with respect to a reference vintage that is variable, or “floating”—it changes from bin to bin. However, similar to the cascaded method, an artifact or error may still be propagated across all vintages and smeared out onto the 3D maps. Accordingly, in some embodiments, by utilizing a centrality measure, propagating of artifacts and errors for 4D multi-vintage destriping may be minimized or eliminated.

Centrality measures may be based on a selected attribute. For example, an attribute may be time-shifts, amplitude, or phase. Time-shifts are calculated using the following equation:

Δtᵢⱼ−dT_{i-dT}ⱼ=0 (2)

where:
Δtᵢⱼ=time-shift between trace i and trace j; and
dTₓ=corrections made to N traces for time alignment.

Finding the set of corrections to be made is accomplished by solving a set of equations, which is written in matrix form, Ax=b. For example, with three traces the matrix is as follows:

$$( \begin{matrix}1 & - 1 & 0 \\ 1 & 0 & - 1 \\ 0 & 1 & - 1\end{matrix} ) ( \begin{matrix}{dT}_{0} \\ {dT}_{1} \\ {dT}_{2}\end{matrix} ) = ( \begin{matrix}Δ {t}_{01} \\ Δ {t}_{02} \\ Δ {t}_{12}\end{matrix} ) . \qquad ( 3 )$$

The matrix is an underdetermined system to which at least one constraint may be added. For example, a set of Lagrange multipliers, λ_{K}, may be introduced, such that:

$${\sum }_{k} {λ}_{k} {dT}_{k} = 0. \qquad ( 4 )$$

The least-squares solution of Equations (3) and (4) provides the corrections. The Lagrange multipliers may be assigned in multiple techniques. For example, in the cascaded method discussed above in which the reference trace is fixed, one multiplier to set to zero and all others are set to one: λ₂=0, λ₂=λ₃=1. Such an assignment aligns the data to the first trace. In the simultaneous multi-vintage method discussed above in which the reference is floating, all multipliers are set to one: λ₁=λ₂=λ₃=1. The solutions of Equations (3) and (4) in this case become:

$${dT}_{i} = \frac{1}{N} {\sum }_{j = 0}^{N - 1} Δ {t}_{ij} . \qquad ( 5 )$$

The correction for each trace is the average of the relative time-shifts to that particular trace. Thus, this illustrates that a floating reference solution, such as the simultaneous multi-vintage method, distributes the artifacts, errors, and differences between the data across all datasets.

In some embodiments, using a centrality measure to choose the reference trace or vintage may reduce or eliminate the propagation of errors and artifacts across all the data. There are multiple centrality measures that may be used in embodiments of the present disclosure. For simplicity and example, closeness centrality that describes the total distance of a node from all other nodes connected to it in a network may be used. Given the time-shifts Δtᵢⱼ we define a time-shift distance matrix T=Δtᵢⱼ| from which the closeness centrality is obtained as:

$${C}_{i}^{T} = \frac{N}{{\sum }_{j = 0}^{N - 1} \vert Δ {t}_{ij} \vert} . \qquad ( 6 )$$

Thus, the trace or vintage with the highest value of centrality may be used as the reference trace, and the Lagrange multipliers may be chosen accordingly. For example, the Lagrange multipliers may be selected via an iterative method to minimize a misfit function or the Lagrange multipliers may be based on the centrality values themselves. In this way, the centrality attribute (or a combination of several centrality attributes) may be used to identify outliers and similarities amongst a set of traces. The attribute can be calculated in a spatial group of traces (for example, shot and sequence consistent) in order to investigate acquisition related effects. Aligning the group with the chosen reference trace ensures minimum total applied time-shift to the group and minimizes the propagation of artifacts across the data.

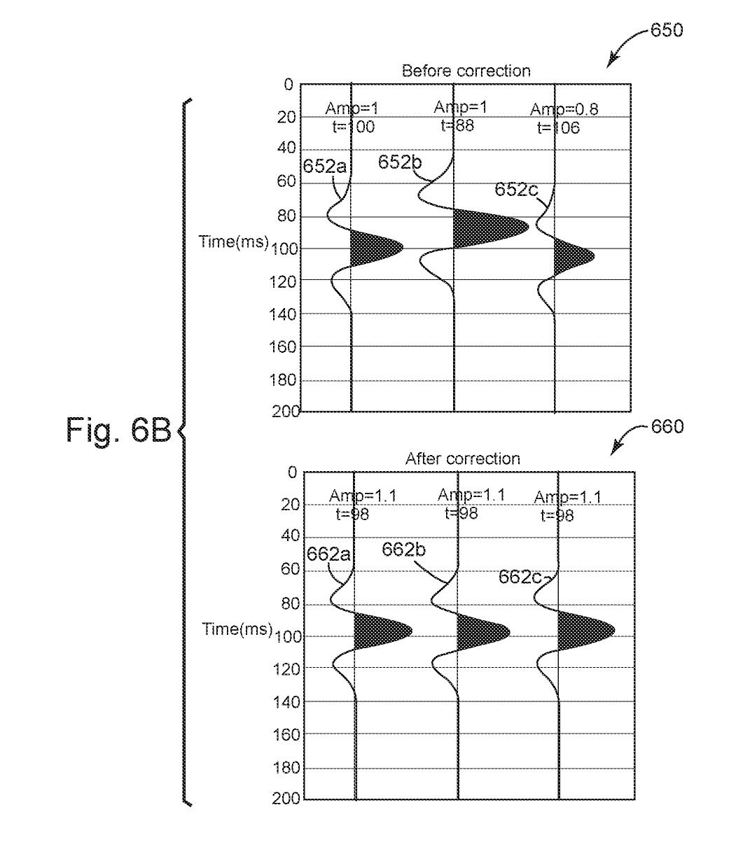

FIG. 6A illustrates a flow chart of an example method 600 of destriping seismic data using a centrality measure in accordance with some embodiments of the present disclosure. The steps of method 600 are performed by a user, various computer programs, models configured to process or analyze seismic data, or any combination thereof. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze seismic data may be referred to as a “computing system.” Method 600 may be used to destripe seismic data for any suitable seismic dataset. Further, although exemplary discussed as applicable to vintage data, method 600 may also be applied to traces and groups of traces.

At step 605, the computing system obtains seismic data from multiple vintages. For example, the computing system may receive seismic data from 4D seismic surveys for three different vintages. As discussed with reference to FIG. 1, the data may be based on collecting data from the same acquisition area at three different times.

At step 610, the computing system generates attribute matrices of the seismic data. Any of a variety of attributes of the seismic data may be chosen. For example, the computing system may generate time-shifts matrices by correlation of the different vintages, as discussed with reference to Equations (2) and (3).

At step 615, the computing system computes a centrality measure for each vintage using the attribute matrices. For example, the computing system may utilize Equation (6) to calculate a closeness centrality measure for each of the vintages. The vintage with the highest closeness centrality measure may be selected as the reference vintage. For example, FIG. 6B illustrates plots 650 and 660 of exemplary traces 652 to which a centrality measure is applied in accordance with some embodiments of the present disclosure. Plot 650 may include traces 652a, 652b, and 652c from a time-lapse experiment. Each trace 652 contains a Ricker wavelet with a different arrival time and amplitude. For example, trace 652a may have an amplitude of approximately 1 and an arrival time of approximately 100 milliseconds. Trace 652b may have an amplitude of approximately 1.5 and an arrival time of approximately 88 milliseconds. Trace 652c may have an amplitude of approximately 0.8 and an arrival time of approximately 106 milliseconds. Plot 660 illustrates each trace after application of correction based on a centrality measure, for example after applying static time-shifts and scalar amplitude corrections. Corrected traces 662a, 662b, and 662c are each at an amplitude of approximately 1.1 and an arrival time of approximately 98 milliseconds. Thus, when corrected for acquisition and environmental differences, each trace is essentially aligned.

Returning to FIG. 6A, at step 620, the computing system determines outliers of the vintage data based on centrality measures or correlation with the reference vintage. For example, if vintage three is chosen as the reference vintage, vintages one and two are both respectively be correlated with vintage three.

At step 625, the computing system weights the contribution of each vintage within the group of vintages based on the centrality measure. The computing system may also calculate a global centrality value based on a weighted combination of the centrality measure for each vintage within the group of vintages and assign a contribution weight to each vintage of the group of vintages based on the global centrality value.

At step 630, the computing system determines the source of any outliers. Outliers identified in step 620 may correspond to noise or stripes on the respective vintage map that should be removed. For example, outliers identified in a correlation between vintage three (reference vintage) and vintage one may correspond to stripes from environmental changes that appear in vintage one data.

At step 635, the computing system removes the outliers from the respective vintages or minimizes the impact by lowering the weight of contribution of a vintage that contains an outlier. For example, the identified outliers in vintage one data may be corrected for and removed from the data. The corrected seismic data may be subsequently utilized to generate images of the subsurface.

Modifications, additions, or omissions may be made to method 600 without departing from the scope of the present disclosure. For example, the order of the steps may be performed in a different manner than that described and some steps may be performed at the same time. Additionally, each individual step may include additional steps without departing from the scope of the present disclosure.

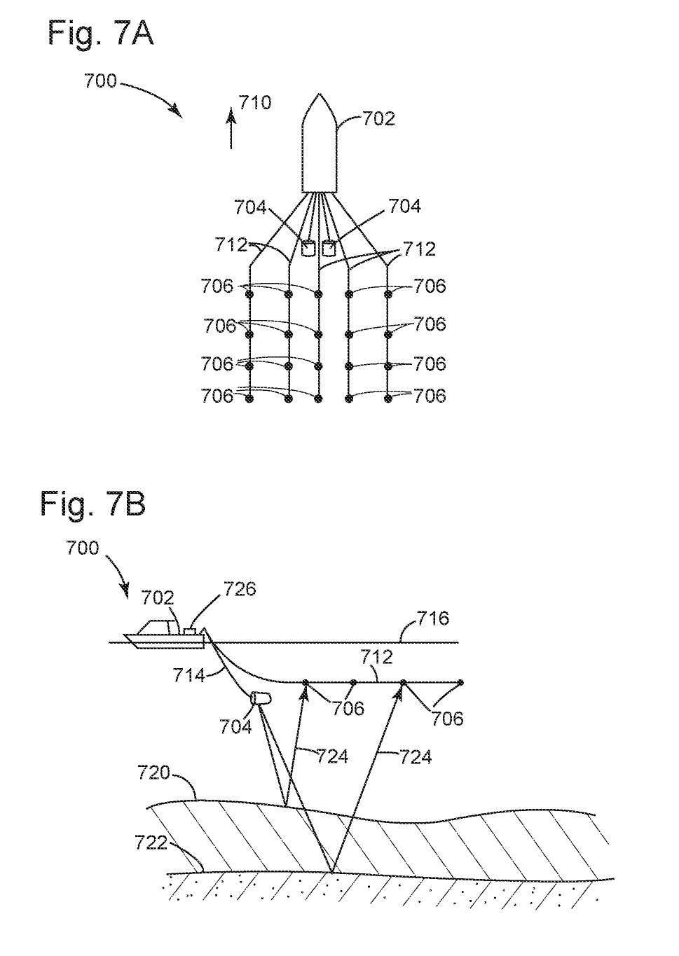

FIG. 7A illustrates a top view of an example marine seismic survey system 700 in accordance with some embodiments of the present disclosure. Vessel 702 is oriented to show the top of the vessel. Although only one vessel 702 is shown, system 700 may include any number of vessels 702. Vessel 702 includes signal source 704. Although only two sources 704 are shown, it should be understood that system 700 may comprise any number of sources 704. Sources 704 may also be referred to as “seismic sources,” “energy sources,” or “seismic energy sources.” Seismic survey system 700 may include sensors 706. Source 704 and sensors 706 may be configured to conduct multiple seismic surveys over time. Sensors 706 may be attached to and towed behind vessel 702 and positioned relative to source 704. Further, although shown in the illustrated embodiments to be on the same vessel 702 as sensors 706, in some embodiments, sources 704 may be on a different vessel 702.

In some embodiments, sensors 706 may be positioned with any appropriate combination of crossline streamer offset (perpendicular to direction of travel 710 of vessel 702), inline offset (along the direction of travel 710 of vessel 702), and depth offset from sources 704 or the water surface. Sensors 706 may be attached or connected to vessel 702 via streamer lines 712. Although four sensors 706 are shown per streamer line 712, any appropriate number of sensors 706 may be coupled to a particular streamer line 712. In some embodiments, sensors 706 may be maintained in a selected position or location using any suitable positioning system. Sensors 706 may be configured to receive seismic signals to generate seismic data. Further, although five streamer lines 712, any appropriate number of streamer lines 712 may be coupled to a particular vessel 702.

FIG. 7B illustrates an exemplary side view of the example marine seismic survey system 700 of FIG. 7A in accordance with some embodiments of the present disclosure. System 700 in the view of FIG. 7B includes vessel 702 oriented to show the side of the vessel. In some embodiments, source 704 is towed on line 714 and may be maintained at a particular source depth below the water surface 716, for example approximately ten meters. Source 704 may be attached to vessel 702 via source towing line 714. Source 704 can include an array of seismic energy sources towed behind vessel 702. Multiple sources 704 may be at varied depths below surface 716. Although only one source 704 is shown on source towing line 714, any appropriate number of sources 704 may be connected to a particular source towing line 714. Additionally, multiple sources 704 may be positioned at a predetermined distance from one another, for example approximately three meters.

In some embodiments, the positions of sources 704 and sensors 706 are monitored using one or more position-measurement mechanisms. For example, system 700 may include an ultra-short baseline (USBL), which measures an angle and distance to each source 704 or sensor 706 using acoustic pulses. System 700 may also include depth sensors, GPS sensors, visible light or infrared transceivers, or any other mechanisms suitable for measuring the positions of sources 704 and sensors 706. During a survey, signals emitted from source 704 are reflected from the ocean bottom 720 or subsurface interfaces 722 and received by sensors 706 as reflected waves 724. Received waves may be recorded as traces by recording or computing system 726.

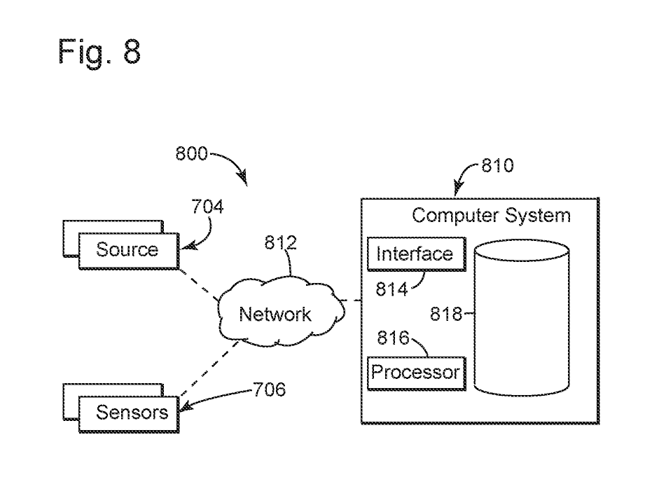

FIG. 8 illustrates a schematic diagram of an example system 800 that can be used to destripe seismic data in accordance with some embodiments of the present disclosure. System 800 includes one or more seismic energy sources 704, one or more sensors 706, and computing system 810, which are communicatively coupled via network 812. System 800 is configured to produce imaging of the earth's subsurface geological formations.

Computing system 810 can generate composite seismic images based on signals generated by a wide variety of sources 704. For example, computing system 810 can operate in conjunction with sources 702 and sensors 706 having any structure, configuration, or function described above with respect to FIG. 7. In some embodiments, sources 704 may be impulsive (such as, for example, explosives or air guns) or vibratory. Impulsive sources may generate a short, high-amplitude seismic signal while vibratory sources may generate lower-amplitude signals over a longer period of time. Vibratory sources may generate a frequency sweep or may generate monofrequencies. Vibratory sources may be instructed, by means of a pilot signal, to generate a target seismic signal with energy at one or more desired frequencies, and these frequencies may vary over time.

In some embodiments, sensors 706 are not limited to any particular types of sensors. For example, in some embodiments, sensors 706 include geophones, hydrophones, accelerometers, fiber optic sensors (such as, for example, a distributed acoustic sensor (DAS)), streamers, or any suitable device. Such devices may be configured to detect and record energy waves propagating through the subsurface geology with any suitable, direction, frequency, phase, or amplitude. For example, in some embodiments, sensors 706 are hydrophones. In offshore embodiments, sensors 706 are situated on or below the ocean floor or other underwater surface. Furthermore, in some embodiments, seismic signals can be recorded with different sets of sensors 706. For example, some embodiments may use dedicated sensor spreads for each type of signal, though these sensor spreads may cover the same area, and each sensor spread can be composed of different types of sensors 706. Further, a positioning system, such as a global positioning system (GPS, GLONASS, etc.), may be utilized to locate or time-correlate sources 704 and sensors 706.

Sources 704 and sensors 706 may be communicatively coupled to computing system 810. One or more sensors 706 transmit raw seismic data from received seismic energy via network 812 to computing system 810. A particular computing system 810 may transmit raw seismic data to other computing systems or other site via a network. Computing system 810 receives data recorded by sensors 704 and processes the data to generate a composite image or prepares the data for interpretation. Computing system 810 may be operable to perform the processing techniques described above with respect to FIGS. 1 through 7B.

Computing system 810 may include any instrumentality or aggregation of instrumentalities operable to compute, classify, process, transmit, receive, store, display, record, or utilize any form of information, intelligence, or data. For example, computing system 810 may be one or more mainframe servers, desktop computers, laptops, cloud computing systems, storage devices, or any other suitable devices and may vary in size, shape, performance, functionality, and price. Computing system 810 may include random access memory (RAM), one or more processing resources such as a central processing unit (CPU) or hardware or software control logic, or other types of volatile or non-volatile memory. Additional components of computing system 810 may include one or more disk drives, one or more network ports for communicating with external devices, various input and output (I/O) devices, such as a keyboard, a mouse, and a video display.

Computing system 810 may be configured to permit communication over any type of network 812. Network 812 can be a wireless network, a local area network (LAN), a wide area network (WAN) such as the Internet, or any other suitable type of network.

Network interface 814 represents any suitable device operable to receive information from network 812, transmit information through network 812, perform suitable processing of information, communicate with other devices, or any combination thereof. Network interface 814 may be any port or connection, real or virtual, including any suitable hardware and/or software (including protocol conversion and data processing capabilities) that communicates through a LAN, WAN, or other communication system. This communication allows computing system 810 to exchange information with network 812, other computing systems 810, sources 704, sensors 706, or other components of system 800. Computing system 810 may have any suitable number, type, and/or configuration of network interface 814.

Processor 816 communicatively couples to network interface 814 and memory 818 and controls the operation and administration of computing system 810 by processing information received from network interface 814 and memory 818. Processor 816 includes any hardware and/or software that operates to control and process information. In some embodiments, processor 816 may be a programmable logic device, a microcontroller, a microprocessor, any suitable processing device, or any suitable combination of the preceding. Computing system 810 may have any suitable number, type, and/or configuration of processor 816. Processor 816 may execute one or more sets of instructions to implement the generation of a composite image based on seismic data, including the steps described above with respect to FIGS. 1 through 7B. Processor 816 may also execute any other suitable programs to facilitate the generation of broadband composite images such as, for example, user interface software to present one or more GUIs to a user.

Memory 818 stores, either permanently or temporarily, data, operational software, or other information for processor 816, other components of computing system 810, or other components of system 800. Memory 818 includes any one or a combination of volatile or nonvolatile local or remote devices suitable for storing information. For example, memory 818 may include random access memory (RAM), read only memory (ROM), flash memory, magnetic storage devices, optical storage devices, network storage devices, cloud storage devices, solid-state devices, external storage devices, any other suitable information storage device, or a combination of these devices. Memory 818 may store information in one or more databases, file systems, tree structures, any other suitable storage system, or any combination thereof. Furthermore, different types of information stored in memory 818 may use any of these storage systems. Moreover, any information stored in memory may be encrypted or unencrypted, compressed or uncompressed, and static or editable. Computing system 810 may have any suitable number, type, and/or configuration of memory 818. Memory 818 may include any suitable information for use in the operation of computing system 810. For example, memory 818 may store computer-executable instructions operable to perform the steps discussed above with respect to FIGS. 1 through 7B when executed by processor 816. Memory 818 may also store any seismic data or related data such as, for example, raw seismic data, reconstructed signals, velocity models, seismic images, or any other suitable information.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. For example, seismic sources 704 in FIGS. 7A, 7B, and 8 may be any combination of vibratory or impulsive seismic sources. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a sensor does not have to be turned on but must be configured to receive reflected energy.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the present disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability. For example, the computing system described in methods 500 and 600 with respect to FIGS. 5 and 6A may be stored in tangible computer readable storage media.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the present disclosure is defined by the appended claims.

What is claimed is:

1. A method for improved analysis of seismic data, the method comprising:
obtaining seismic data including a plurality of vintages;
generating a plurality of attribute matrices based on the seismic data;
computing a centrality measure for each vintage of the plurality of vintages using the plurality of attribute matrices;
selecting, from the plurality of vintages, a vintage with the highest centrality measure as a reference vintage; and
determining an outlier from the plurality of vintages based on correlating each of the plurality of vintages with the reference vintage.

2. The method of claim 1, further comprising calculating a global centrality value based on a weighted combination of the centrality measure for each vintage of the plurality of vintages.

3. The method of claim 2, further comprising assigning a contribution weight to each vintage of the plurality of vintages based on the global centrality value.

4. The method of claim 3, further comprising lowering the contribution weight of at least one vintage from the plurality of vintages.

5. The method of claim 1, further comprising determining the source of any outliers.

6. The method of claim 5, further comprising correlating the outlier to a sequence number of the determined vintage.

7. The method of claim 1, wherein the outlier comprises a stripe.

8. A seismic processing system, comprising:
a computing system configured to:
obtain seismic data including a plurality of vintages;
generate a plurality of attribute matrices based on the seismic data;
compute a centrality measure for each vintage of the plurality of vintages using the plurality of attribute matrices;
select, from the plurality of vintages, a vintage with the highest centrality measure as a reference vintage; and
determine an outlier from the plurality of vintages based on correlating each of the plurality of vintages with the reference vintage.

9. The system of claim 8, wherein the computing system is further configured to calculate a global centrality value based on a weighted combination of the centrality measure for each vintage of the plurality of vintages.

10. The system of claim 9, wherein the computing system is further configured to assign a contribution weight to each vintage of the plurality of vintages based on the global centrality value.

11. The system of claim 10, wherein the computing system is further configured to lower the contribution weight of at least one vintage from the plurality of vintages.

12. The system of claim 8, wherein the computing system is further configured to determine the source of any outliers.

13. The system of claim 12, wherein the computing system is further configured to correlate the outlier to a sequence number of the determined vintage.

14. The system of claim 8, wherein the outlier comprises a stripe.

15. A non-transitory computer-readable medium, comprising:
computer-executable instructions carried on the computer-readable medium, the instructions, when executed, causing a processor to:
obtain seismic data including a plurality of vintages;
generate a plurality of attribute matrices based on the seismic data;
compute a centrality measure for each vintage of the plurality of vintages using the plurality of attribute matrices;
select, from the plurality of vintages, a vintage with the highest centrality measure as a reference vintage; and
determine an outlier from the plurality of vintages based on correlating each of the plurality of vintages with the reference vintage.

16. The non-transitory computer-readable medium of claim 15, wherein the processor is further caused to calculate a global centrality value based on a weighted combination of the centrality measure for each vintage of the plurality of vintages.

17. The non-transitory computer-readable medium of claim 16, wherein the processor is further caused to assign a contribution weight to each vintage of the plurality of vintages based on the global centrality value.

18. The non-transitory computer-readable medium of claim 17, wherein the processor is further caused to lower the contribution weight of at least one vintage from the plurality of vintages.

19. The non-transitory computer-readable medium of claim 15, wherein the processor is further caused to determine the source of any outliers.

20. The non-transitory computer-readable medium of claim 19, wherein the processor is further caused to correlate the outlier to a sequence number of the determined vintage.
